(19) United States
(12) Patent Application Publication
(10) Pub. No.: US 2006/0062651 A1
(43) Pub. Date: Mar. 23, 2006

(54) Fixing part

(76) Inventors: Wen-Chin Kuo, Taoyuan (TW); Hong-Cheng Sheu, Taoyuan (TW)

Correspondence Address: HARNESS, DICKEY & PIERCE, P.L.C., P.O. BOX 8910, RESTON, VA, 20195, US

(21) Appl. No.: 11/030,950

(22) Filed: Jan. 10, 2005

(30) Foreign Application Priority Data
Sep. 21, 2004 (TW) 93215090

(51) Int. Cl. F16B 37/02

(52) U.S. Cl. 411/172

(57) ABSTRACT

A fixing part, comprises: a body, having a screw hole in the central and a hook extending upward form one side of the body; and a screw, having a head and a thread rod axially extending from the head, wherein the thread rod has a fastening section far from the head, and the thread rod of screw screws into the body through the screw hole. When the fixing part is fastened in a device with the hook, the device is able to be fixed to equipment by screwing the screw with the fastening section.

### FIELD OF THE INVENTION

The present invention relates to a fixing part and particularly to a fixing part to facilitate fastening of a device to a baseboard or equipment.

### BACKGROUND OF THE INVENTION

Refer to FIGS. 1A and 1B for a conventional fixing part. As shown in the drawings, the fixing part includes a body 1, a sleeve 3 and a screw 5.

The body 1 has a screw hole 7 in the center to couple with the screw 5 and a hook 11 extended from one side to latch in a corresponding slot formed on a device.

The sleeve 3 is engaged with the screw 5 for fastening.

The screw 5 has a head 19 with a screwing notch 17 formed thereon and a thread rod 21 extended from the head 19. The screw 5 may be coupled on the body 1 through the screw hole 7 on the body 1 by a screwdriver, and be engaged with the sleeve 3 for fastening.

Refer to FIGS. 2A and 2B for an embodiment of the fixing part set forth above. A device 23 is fastened to a baseboard or equipment 25 through a plurality of fixing parts 27. The baseboard 25 has a housing opening 24 to hold the device 23. The device 23, such as a control panel, is held securely on the baseboard 25 through the fixing parts 27.

The device 23 has a slot 26 corresponding to the hook 11 of the body 1 of the fixing part 27. The fixing part 27 is coupled on the device 23 by the hook 11 buckling into the slot 26. After fixing part 27 is coupled on the device 23, the sleeve 3 may be coupled on the screw 5 and turned to make one side of the head 19 press tightly against the baseboard, so that the fixing part 27 could fasten the device 23 to the base board or equipment 25.

However, during the operation above, there is not enough room for user to disassemble. Moreover, using the sleeve to engage with the screw tends to loosen when the baseboard or the equipment is vibrating or shaking. Then, the device could fall off due to the loose screw, and a gap may be produced between the device and the baseboard or equipment, making water easily permeate into it and results in a short circuit.

In the other hand, the fixing part 27 can be first assembled by the coupling of sleeve 3 and screw 5 and uses the same procedure described above to couple on the device 23. The coupling of sleeve 3 and screw 5 could be accomplished by welding or other permanent fastening method. In this case, if the welding procedure is not very well, the fixing part 27 should be dumped and its cost would be increased.

### SUMMARY OF THE INVENTION

In view of the aforesaid problems, the primary object of the present invention is to provide a fixing part that can easily and securely fasten a device to a baseboard with fewer elements.

In order to achieve the foregoing object, the fixing part according to the invention aims to fasten a device to equipment. The fixing part includes a body, which has a screw hole in the center and a hook extended upwards from one side of the body, and a screw which has a head, a thread rod extended axially from the head and a fastening section formed on a distal end of the thread rod remote from the head. The screw may be coupled on the body by screwing the thread rod into the screw hole. After having coupled the hook of the fixing part on the device, the fastening section may be easily turned by screwdriver to move the screw against the surface of the equipment to fasten the device firmly on the equipment.

In addition, the body has two other sides extended upwards.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are schematic views of a conventional fixing part.

FIGS. 2A and 2B are schematic views of an embodiment of the conventional fixing part shown in FIGS. 1A and 1B in a use-condition.

FIGS. 3A and 3B are schematic views of the fixing part of the invention.

FIGS. 4A and 4B are schematic views of an embodiment of the fixing part of the invention shown in FIGS. 3A and 3B in a use-condition.

FIG. 5 is a sectional view of the fixing part shown in FIG. 4 and a device in a coupled condition.

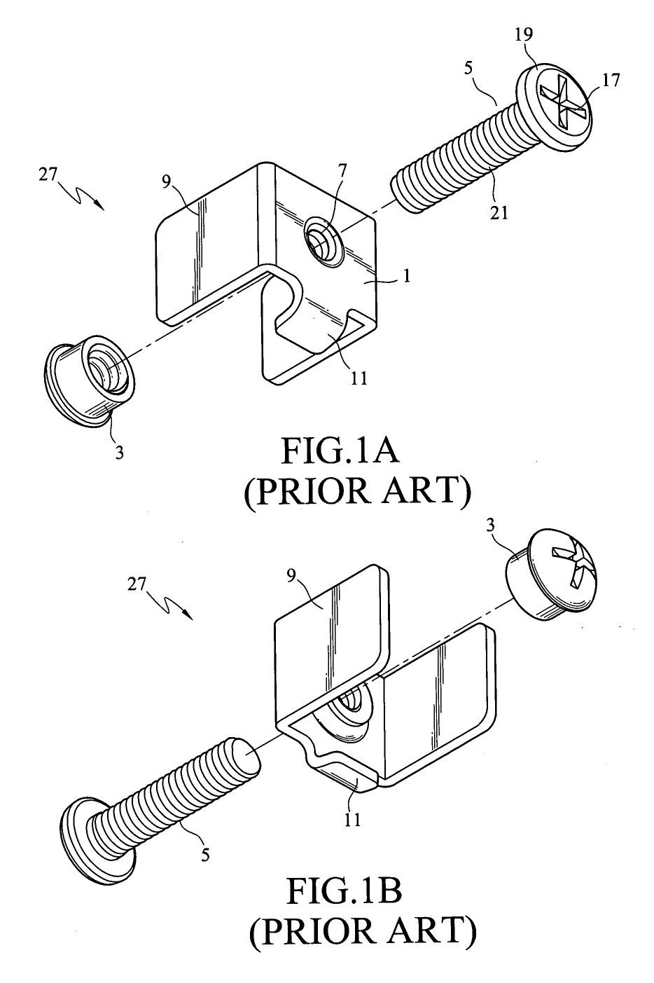

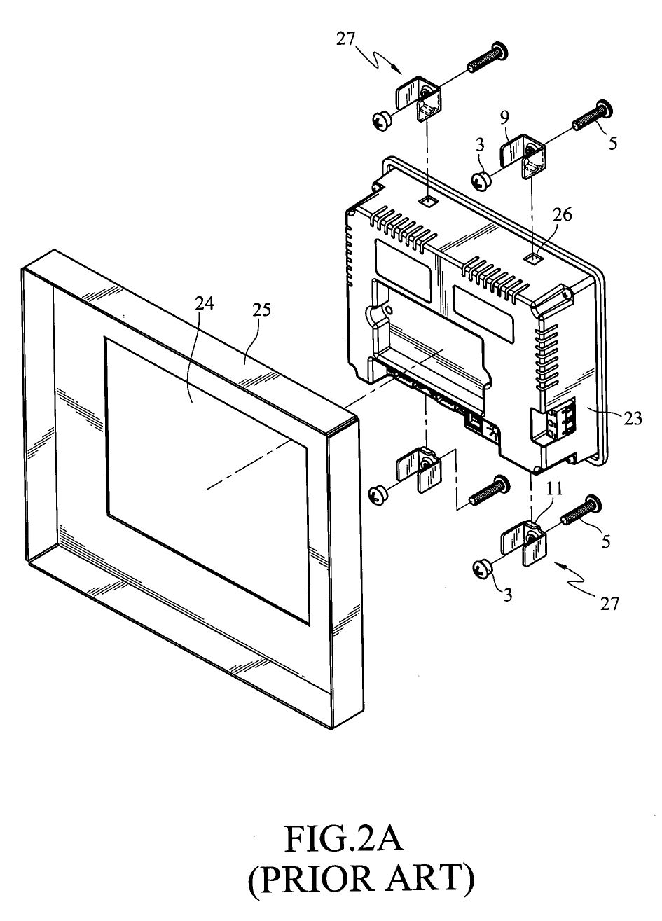

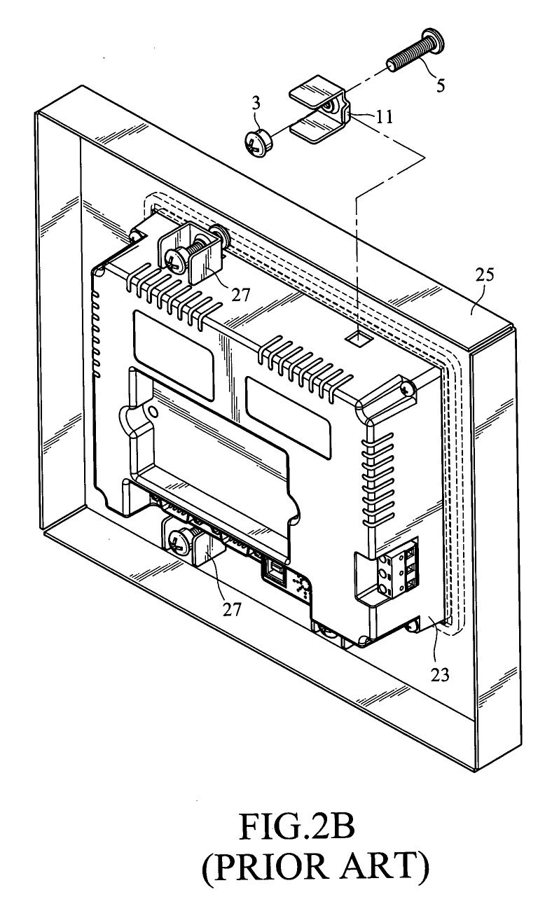

### DESCRIPTION OF THE PREFERRED EMBODIMENTS

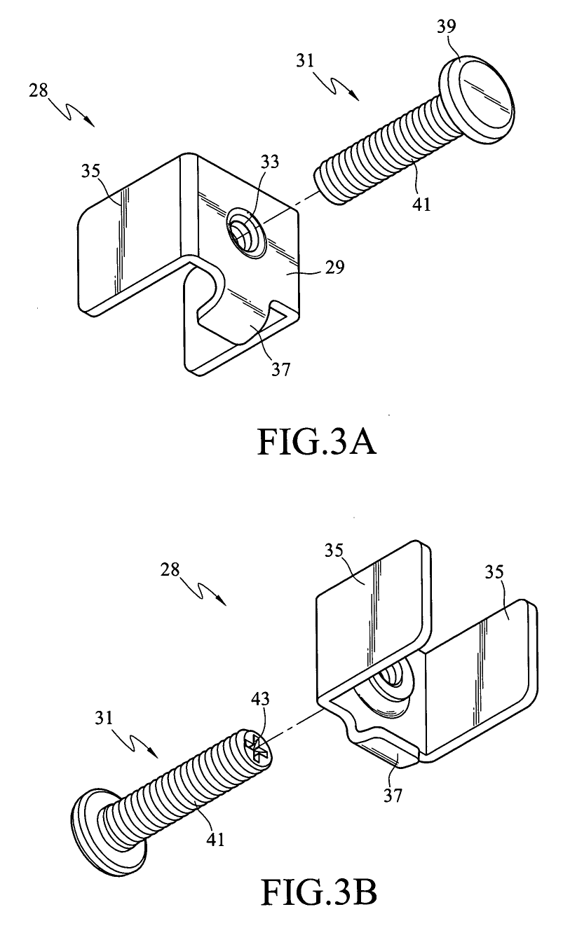

Referring to FIGS. 3A and 3B, the fixing part 28 according to the invention includes a body 29 and a screw 31. The body 29 has a screw hole 33 in the center to engage with the screw 31. The body 29 has two sides extended vertically to form two wing flaps 35 and another side extended to form a hook 37 for inserting into a latch hole formed on device.

The screw 31 has a head 39 and a thread rod 41 extended from the head 39. The thread rod 41 has a distal end remote from the head 39 to form a fastening section 43. The screw 31 thus formed may be engaged with the body 29 through the screw hole 33. Fabrication of the body 29 includes the following steps: forming the profile of the body 29 by stamping with molds, such as the wing flaps 35 and the hook 37; next, drilling a hole and forming the screw hole 33 in the center of the body 29 by tapping. Finally: plating the body 29.

The screw 31 may be fabricated through the following steps: forming the screw 31 in a required shape, including the head 39 and the thread rod 41 extended from the head; punching the distal end of the thread rod 41 remote from the head 39 to form the fastening section 43. Finally: plating the screw 31.

The screw 31 thus formed can be engaged with the screw hole 33 of the body 29 to form the fixing part 28.

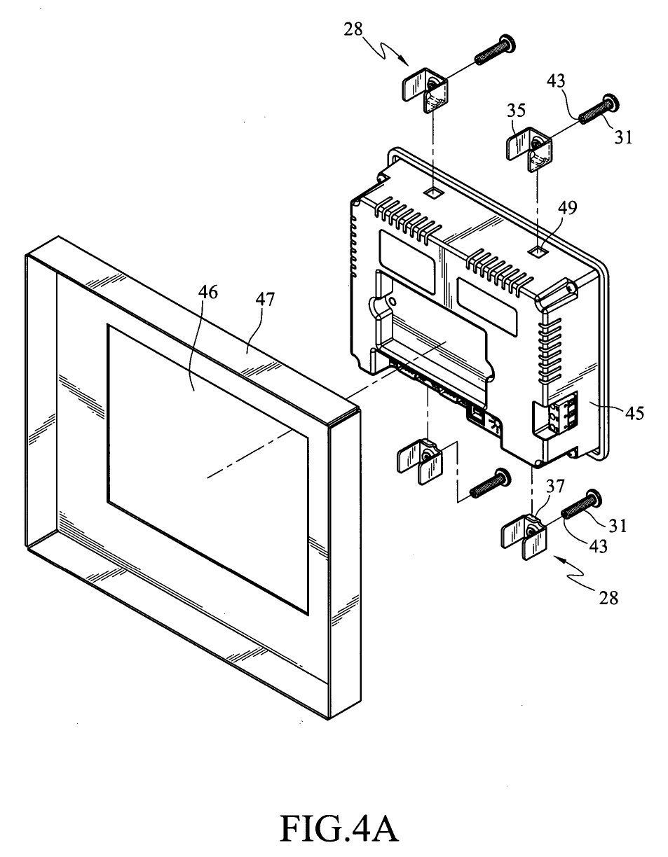

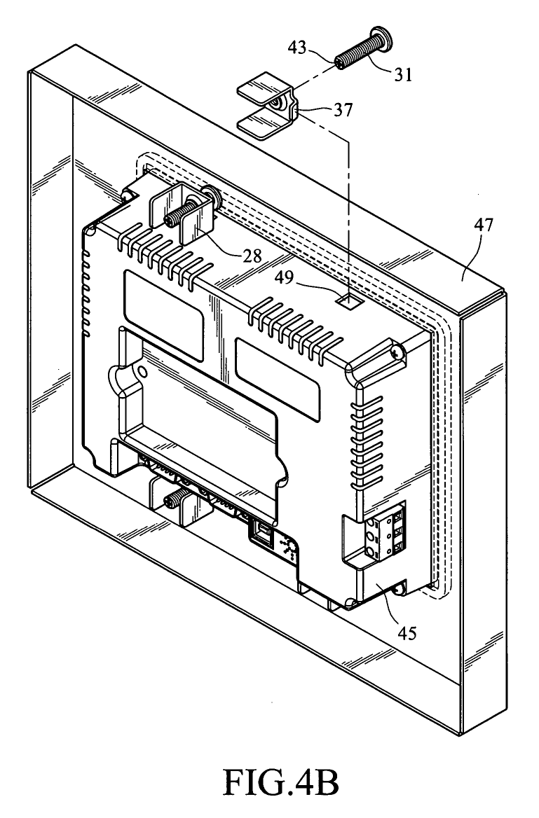

Refer to FIGS. 4A and 4B for an embodiment of the invention in use. A device 45 is to be fastened to a baseboard or equipment 47 by means of a plurality of fixing parts 28 shown in FIGS. 3A and 3B. The equipment 47 has a housing opening 46 to hold the device 45 which is fastened by the fixing parts 28. The device 45 may be a control panel.

As shown in FIGS. 4A and 4B, the hook 37 on the body 29 of the fixing part 28 is inserted into a corresponding latch hole 49 formed on the device 45, then the fastening section 43 on the distal end of the thread rod 41 may be turned by a screw driver to push the head 39 of the screw 31 against the surface of the equipment 47 to fasten the device 45 firmly on the equipment 47.

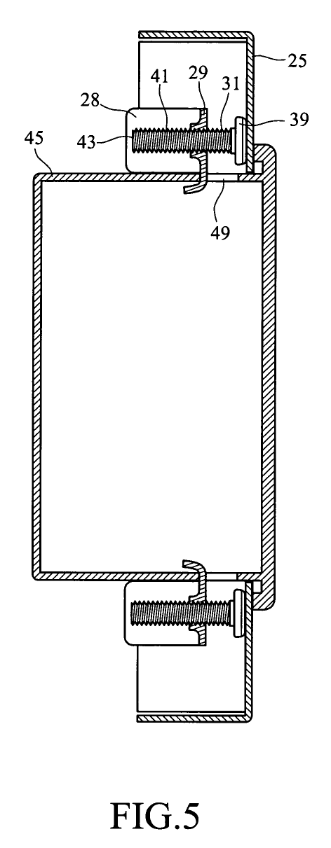

Refer to FIG. 5 for the mechanism for fastening the device 45 to the equipment 47 through the fixing part 28. The fixing part is connected to the device 45 with the hook 37 inserted into the latch hole 49. Then by screwing the fastening section 43 on the distal end of the thread rod 41 remote from the head 39 to make the head 39 of the screw 31 move forward and press against the surface of the equipment 25, so that the hook 37 will engage with the device 45 and hold the device 45 securely in the housing opening 46 (also referring to FIG. 4A).

The fastening section 43 could be a cross style or slot style.

By means of the aforesaid construction, the fixing part can fasten the device to the equipment through the fastening section on the distal end of the thread rod without using a sleeve. Fabrication of the fixing part is simpler and production costs may be reduced.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A fixing part, comprising:
a body having a screw hole in the center and a hook extended upwards from one side thereof, and
a screw having a head and a thread rod extended axially from the head, the thread rod having a fastening section formed on one end remote from the head to couple the screw with the body.

2. The fixing part of claim 1, wherein the body has two other sides extended upwards to form a pair of wing flaps.

3. The fixing part of claim 1, wherein the fastening section is a slot style.

4. The fixing part of claim 1, wherein the fastening section is a cross style.
